(19) United States
(12) Patent Application Publication
(10) Pub. No.: US 2004/0106415 A1
(43) Pub. Date: Jun. 3, 2004

(54) Position information management system

(75) Inventors: Yoshiharu Maeda, Kawasaki (JP); Kuniharu Takayama, Kawasaki (JP); Hirohisa Naito, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/720,087

(22) Filed: Nov. 25, 2003

Related U.S. Application Data
(63) Continuation of application No. PCT/JP01/04512, filed on May 29, 2001.

(51) Int. Cl. H04Q 7/20

(52) U.S. Cl. 455/456.1; 455/456.2; 455/404.1; 455/435.1

(57) ABSTRACT

Position information measured by a terminal of a mobile body is encrypted and transmitted to a position recording center. The position recording center accumulates the position information of each mobile body in the encrypted state. The mobile body or a position information service center providing predetermined position information services to the mobile body can not decrypt other person's position information recorded by the position recording apparatus without the permission of the person. Therefore, it is possible to manage the position information of the mobile body without infringing the privacy of the mobile body. Furthermore, high-level security can be secured since the position recording apparatus itself can not decrypt the accumulated position information without obtaining the key for decryption from the mobile body.

### TECHNICAL FIELD

The present invention relates to a position information management system for managing position information of a mobile body that can utilize the position information while securing the protection of the privacy related to the position information of the mobile body.

### BACKGROUND ART

A position information utilizing system for providing various services utilizing position information obtained by measuring the location of a mobile body (for example, longitude and latitude) is known. Here, a mobile body means what is movable including a human, an animal, a vehicle, an article etc.

FIG. 17 is a diagram showing an example of the structure of a position information utilizing system. In FIG. 17, the position information utilizing system is structured comprising a terminal (for example, a mobile phone terminal with a GPS function) carried by a mobile body and having functions for measuring the location of the mobile body and for transmitting the position information measured, and a position information service center (for example, a server providing Web-sites on the Internet) for receiving the position information from the terminal of the mobile body through a network and providing various services to the terminal utilizing the position information.

The various services include, for example, (1) a navigation service for guiding a mobile body such as a human or a vehicle to its destination, (2) an area-information providing service for providing information on a town (the positions of stores, restaurants, etc) near the location of a mobile body, (3) an emergency notice service for notifying the location of a mobile body in an emergency such as an accident, (4) a mobile body position management service for managing the location of a mobile body such as an old person, a child or a staff member and (5) a tracking service for tracking and monitoring the position of an item such as an article on the way of delivery.

However, there is a problem in the conventional position information management system as follows. That is, since the position information transmitted from a terminal of a mobile body is send out to a position information service center in a readable format, the position information service center can utilize freely the position information of the mobile body. Even when the position information is encrypted for prevention of tapping or for compression in the communication between the terminal and the position information service center, such encryption is not executed against the position information service center since the position information service center can decrypt the encrypted position information.

Therefore, when the mobile body is, for example, a human, the location of the person becomes apparent to the position information center and this gives rise to a problem in terms of privacy.

### DISCLOSURE OF THE INVENTION

It is therefore the object of the present invention to provide a position information management system capable of protecting the privacy related to the location of a mobile body.

A position information management system of the invention for achieving the above object is a position information management system for managing position information of at least one (1) mobile body, comprising a terminal for measuring the position of the mobile body, encrypting the measured position information with a predetermined encryption means and transmitting the encrypted position information, and a position recording apparatus for recording the position information in the encrypted state.

In this manner, the position information measured by the terminal of the mobile body is encrypted by the encryption means specific to the mobile body and transmitted to the position recording center. The position recording apparatus accumulates position information of each mobile body in the encrypted state. The mobile body or the position information service center providing predetermined position information services to the mobile body can not decrypt other person's position information recorded by the position recording apparatus without the permission of the person. Therefore, it is possible to manage the position information of the mobile body without infringing the privacy of the mobile body. Furthermore, high-level security can be secured since the position recording apparatus itself can not decrypt the accumulated position information without obtaining the key for decryption from the mobile body.

### BRIEF DESCRIPTION OF DRAWINGS

FIG. 1 is a diagram showing an example of the structure of a position information management system according to an embodiment of the invention;

FIG. 2 is a diagram showing an example of encryption of position information;

FIG. 3 is a transmitting operation flowchart of position information at a terminal 10;

FIG. 4 is a schematic process flowchart for a position recording center 20;

FIG. 5 is a schematic diagram of a mode of use 1 of the position management system according to the embodiment;

FIG. 6 is a process flowchart of the mode of use 1;

FIG. 7 is a schematic diagram of a mode of use 2 of the position management system according to the embodiment;

FIG. 8 is a process flowchart of the mode of use 2;

FIG. 9 is a schematic diagram of a mode of use 3 of the position management system according to the embodiment;

FIG. 10 is a process flowchart of the mode of use 3;

FIG. 11 is a schematic diagram of a mode of use 4 of the position management system according to the embodiment;

FIG. 12 is a process flowchart of the mode of use 4;

FIG. 13 is a schematic diagram of a mode of use 5 of the position management system according to the embodiment;

FIG. 14 is a process flowchart of the mode of use 5;

FIG. 15 is a schematic diagram of a mode of use 6 of the position management system according to the embodiment;

FIG. 16 is a process flowchart of the mode of use 6; and

FIG. 17 is a diagram showing an example of the structure of a position information utilizing system.

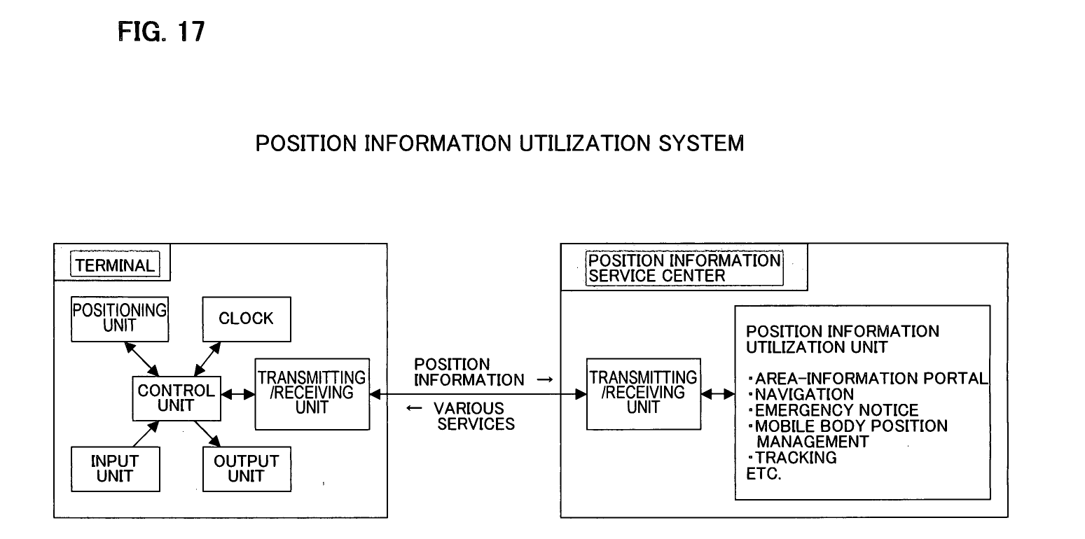

### BEST MODE FOR CARRYING OUT THE INVENTION

An embodiment of the invention will be described with reference to the drawings. However, the technical scope of the invention is not intended to be restricted to the embodiment.

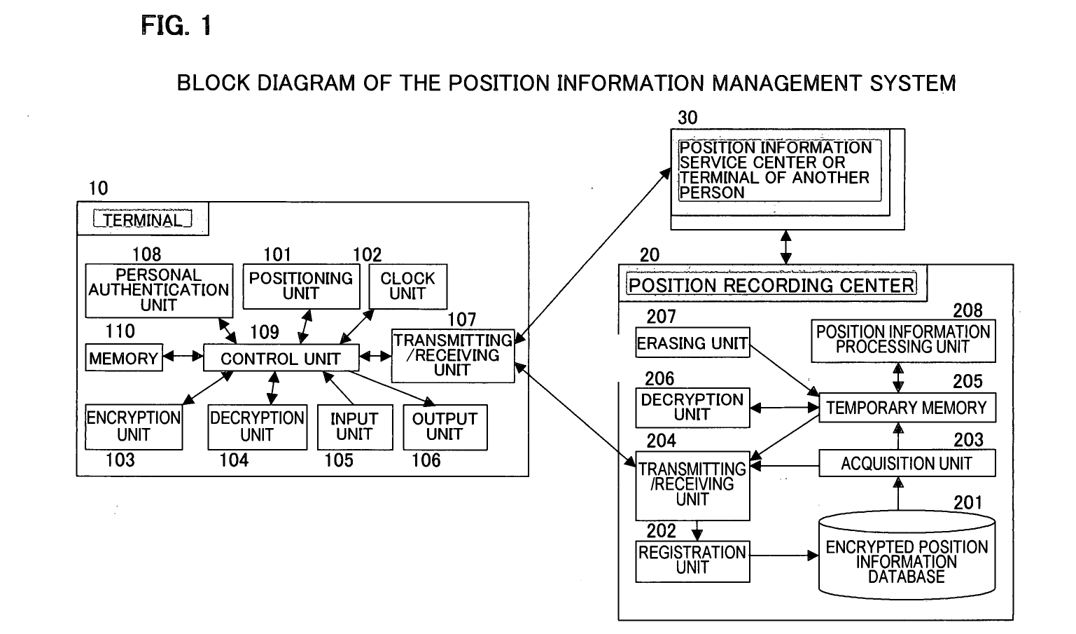

FIG. 1 is a diagram showing an example of the structure of a position information management system according to an embodiment of the invention. In FIG. 1, the position information management system according to the embodiment comprises a terminal 10 (for example, a mobile phone terminal with a GPS function) carried by a mobile body and having functions for measuring the location of the mobile body and for transmitting the position information measured, and a position recording center 20 (position recording apparatus) for receiving and accumulating the position information and, depending on the form of use, may further comprise a position information service center 30.

<Structure of the Terminal 10>

The terminal 10 comprises a positioning unit 101, a clock unit 102, an encryption unit 103, a decryption unit 104, an input unit 105, an output unit 106, a personal authentication unit 108, a transmitting/receiving unit 107 and a control unit 109. The positioning unit 101 positions the current position of the terminal 10. The timing for measurement is controlled by the control unit 109 based on the settings and instructions inputted from the clock unit 102 and the input unit 105.

For measuring the current position, there are some methods such as, for example, (1) GPS (Global Positioning System) using radio wave from artificial satellites or a positioning method using radio wave from a plurality of places, (2) a self-sustaining navigation method in which the directions and distances of the move are integrated using a direction sensor such as a gyro and a velocity sensor, (3) a hybrid method in which (1) and (2) are combined, (4) a method (the Publication of the Japanese Unexamined Patent Application No. 1988-010300) in which an apparatus having a function for identifying its position is placed in advance at the position to be measured and (5) a method utilizing the position of base stations for PHS (Personal Handy Phone System) or mobile phones.

The position coordinates of the current position obtained by the positioning unit 101 may be expressed in the following formats.

Longitude and latitude: ex.) (N35.123.456, E130.123.456)

Displacement from a designated datum point (longitude and latitude):

ex.) with the datum point (N35.123.456, E130.123.456), displacement is (+0.234.567, −0.123.456) or (direction; 130 degrees, distance xxx meters).

The clock unit 102 measures and accumulates time and outputs the time of measurement, at which the current position is measured by the positioning unit 101. The clock unit 102 is also used for controlling the timing for the positioning unit 101 and the transmitting/receiving unit 108.

The encryption unit 103 encrypts position information including the position coordinates of the current position measured by the positioning unit 101. The position information preferably includes the time of the measurement corresponding to each position coordinate. For the encryption of the position information, there are methods, for example, as follows.

Encryption of only position coordinates without encrypting the time of measurement.

Encryption of a combination of a position coordinate and the time of measurement as one item.

Encryption of a plurality pieces of position information (combinations of position coordinates and the time of measurement) altogether.

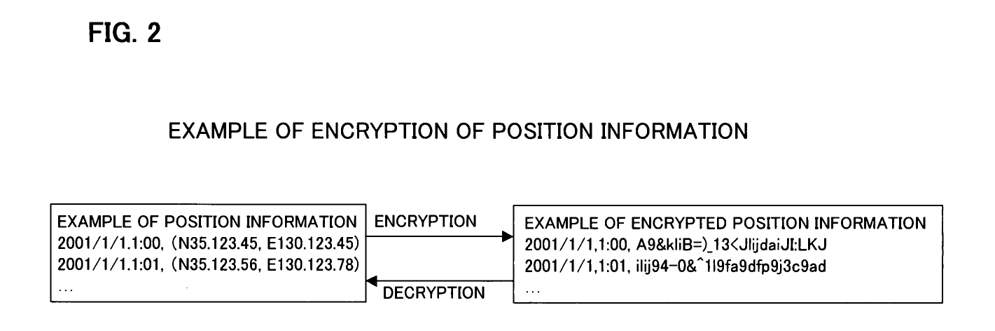

FIG. 2 is a diagram showing an example of encryption of position information. The encryption unit 103 encrypts position information using a public key cryptosystem or a private key cryptosystem. The public key cryptosystem is a cryptosystem in which data is encrypted and decrypted using paired two (2) keys, and is also referred to as asymmetric encryption. The private key cryptosystem is a cryptosystem in which a same key is used for encryption and decryption, and is also referred to as “shared key cryptosystem” and “compatible key cryptosystem”.

The encryption unit 103 may be adapted to be able to designate and change the encryption method, for example, as follows in addition to the case where one encryption method is always used.

Encryption method used is changed according to time. For example, an encryption method A is used for encrypting from 8:00 a.m. to 5:00 p.m. and an encryption method B is used for encrypting during the time except that.

The encryption method used is changed depending on the place to use it. For example, an encryption method A is used for encrypting when an mobile body is present in a certain area and an encryption method B is used for encrypting when it is present in other areas.

The encryption method used is changed depending on the time and the place to use it. For example, an encryption method A is used for encrypting when an mobile body is present in a certain area at a certain time and an encryption method B is used for encrypting when it is present in other areas at another time.

The encryption method used is changed depending on the designation of the user. For example, an encryption method A is changed to encryption method B by the designation from the user.

In those cases, manners for changing the encryption methods are as follows.

Only the encryption key is changed without changing the type of the public key cryptosystem or the private key cryptosystem used.

The type of the public key cryptosystem or the private key cryptosystem used is changed.

By changing the encryption method depending on the time, places or user's designation as described above, the user can designate the time and the place at which the position information may be known by others in each mode of use of a position information management system according to an embodiment described later.

The decryption unit 104 decrypts the position information encrypted by the encryption unit 103 and converts the position information into a readable format. The input unit 105 is a unit for the user to execute various setting and inputting operations to the terminal 10. There are setting and inputting operations as follows as examples,

Setting of the timing of measurement.

Setting of the timing of transmitting the position information.

Setting of whether to transmit/not to transmit the position information

Setting of the selection of position information service centers.

Setting of the encryption method used.

Inputting of transmission order.

Inputting of transmission permission of the encryption key.

The output unit 106 outputs various kinds of information from the terminal 10. The information outputted is, for example, as follows.

Measured position information.

Information received from the position recording center 20.

Information received from the position information service center.

Values to be set at the terminal 10.

The transmitting/receiving unit 107 transmits and receives various kinds of information between the terminal 10 and the position recording center 20, or between the terminal 10 and the position information center 30, using networks such as the Internet and the public telephone network. The timing to transmit is controlled by the control unit 109.

The personal authentication unit 108 authenticates the user bearing the terminal 10. The methods for authentication of a person are, for example, as follows.

A method in which a user ID and a password are used.

A method in which biometrics such as a finger print or an iris are used.

It is possible to prevent another person from disinforming the position information using the terminal 10 by the personal authentication unit 108. Only in the case where the personal authentication is successfully completed, it is possible to encrypt the position information and transmit the encrypted position information. The timing to request the personal authentication is controlled by the control unit 109.

The control unit 109 controls the positioning unit 101, the clock unit 102, the encryption unit 103, the decryption unit 104, the input unit 105, the output unit 106, the transmitting/receiving unit 107, personal authentication unit 108 etc. There are controls of the control unit 109, for example, as follows.

Timing control of positioning.

Timing control of encryption.

Control of whether to permit or not to permit and timing control of transmission of a position.

Control of encryption method used.

A memory 110 stores various data. The information to be memorized is, for example, as follows.

Position information measured by the positioning unit 101.

A key for encryption by the encryption unit 103.

Setting data for control of the control unit 109.

Buffer data at the input unit 105, output unit 106 and transmitting/receiving unit 107.

Data for personal authentication at the personal authentication unit 108.

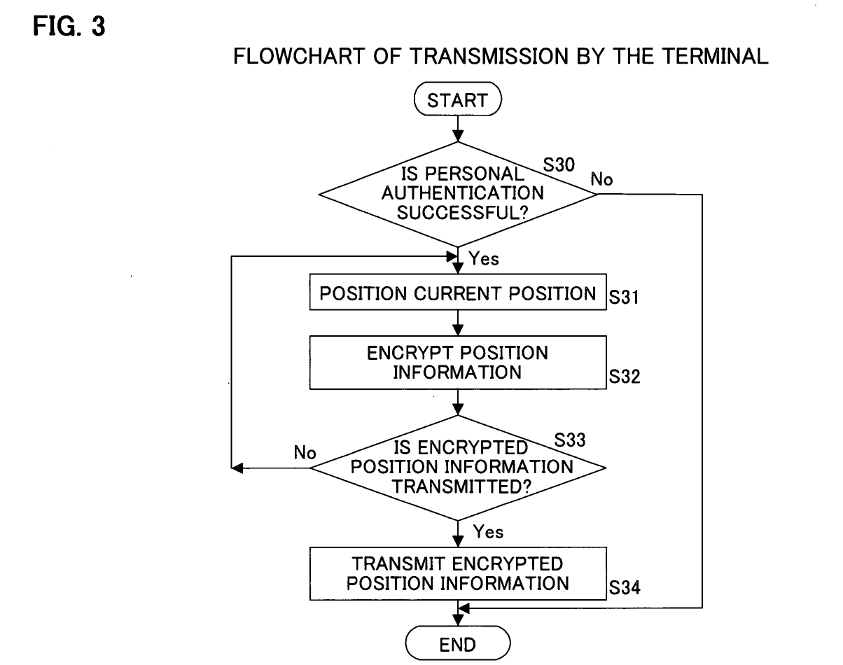

FIG. 3 is a transmitting operation flowchart of the position information at the terminal 10. In FIG. 3, the personal authentication unit 108 executes personal authentication with predetermined personal authentication information (for example, a user ID and a password) inputted by the user from the input unit 105. When the personal authentication has been successfully completed (S30), the positioning unit 101 measures the current position at a predetermined timing (S31). The encryption unit 103 encrypts the position information (including at least the measured position coordinates and, preferably, further includes the time of the measurement) (S32). When the encrypted position information is transmitted (S33), the transmitting/receiving unit 107 transmits the encrypted position information (S34).

<Structure of the Position Recording Center 20>

In FIG. 1, the position recording center 20 comprises an encrypted position information database 201, a registration unit 202, an acquisition unit 203, a transmitting/receiving unit 204, a temporary memory 205, a decryption unit 206, an erasing unit 207 and a position information process unit 208.

The encrypted position information database 201 stores/records the encrypted position information received from the terminal 10 separately for each user in the encrypted state. The encrypted position information database 201 may further store the follow information.

User information such as the attribute, preference, history of each user.

The result of the process by the position information process unit 208 if permitted.

Since the position information stored in the encrypted position information database 201 is encrypted as described above, the position recording center 20 itself can not decrypt the encrypted position information as far as it has not obtained the encryption key from the mobile body (user). Therefore, it is possible to accumulate and record the position information of the mobile body without infringing the privacy of the mobile body and, as described later, it is possible to provide various services utilizing the accumulated position information, protecting the privacy of the mobile body.

The registration unit 202 registers the encrypted position information received from the terminal 10 into the encrypted position information database 201. The acquisition unit 203 acquires (reads out) the encrypted position information from the encrypted position information database 201 in response to an encrypted position information acquisition request from the terminal 10 or the position information service center 30. At this moment, the acquisition unit 203 determines whether the originator of the request is the terminal 10 or the position information service center 30 permitted by the user him/herself being the target of the encrypted position information, and acquires the encrypted position information only when it is permitted to do so. The determination is executed with, for example, the ID of the terminal 10 or the position information service center 30, contained in the request.

The transmitting/receiving unit 204 transmits and receives various kinds of information between the position recording center 20 and the terminal 10 or between the position recording center 20 and the position information service center 30. Networks such as the Internet and the public telephone lines may be utilized for the communication.

The temporary memory 205 stores temporarily various kinds of information. The information stored in the temporary memory 205 can not be read out for any uses except the designated ones. The information stored in the temporary memory 205 is, for example, as follows.

The encrypted position information acquired by the acquisition unit 203 from the encrypted position information database 201.

The encryption key received from the terminal 10.

The position information decrypted by the decryption unit 206.

The result of the information process executed by the position information process unit 207 based on the decrypted position information.

An erasing unit 207 erases the information stored in the temporary memory 205 and causes the decrypted position information and the encryption key not to remain in the position recording center 20 and/or not to be re-utilized for other objectives.

The position information process unit 208 executes various processes based on the encrypted position information or decrypted position information. The processes executed by the position information process unit 208 are, for example, as follows.

A process for sending the encrypted position information acquired from the encrypted position information database 201, to another designated terminal or a designated position information service center.

A process for decrypting, under the permission of the user, the encrypted position information acquired from the encrypted position information database 201, and for sending the decrypted position information to another terminal or a designated position information service center.

A process for decrypting, under the permission of the user, the encrypted position information acquired from the encrypted position information database 201, sending the decrypted position information to a designated position information service center, acquiring an information service from the position information service center and sending the result of acquisition to the terminal.

A process for obtaining information services from a plurality of position information service centers and sending the information services to the information terminal after compiling them.

A process for decrypting, under the permission of the user, the encrypted position information acquired from the encrypted position information database, processing the decrypted position information and sending the result of the process to the user or a designated terminal.

A process for, in response to a query from outside, relating to the owner of position records, decrypting, under the permission of the target of the query, the encrypted position information obtained from the encrypted position information database 201, processing the decrypted position information, and creating and issuing a response to the query.

A process for, when decryption of the encrypted position information is permitted by a plurality of users, processing position information of the plurality of users and sending the result of the process to the users or a designated terminal.

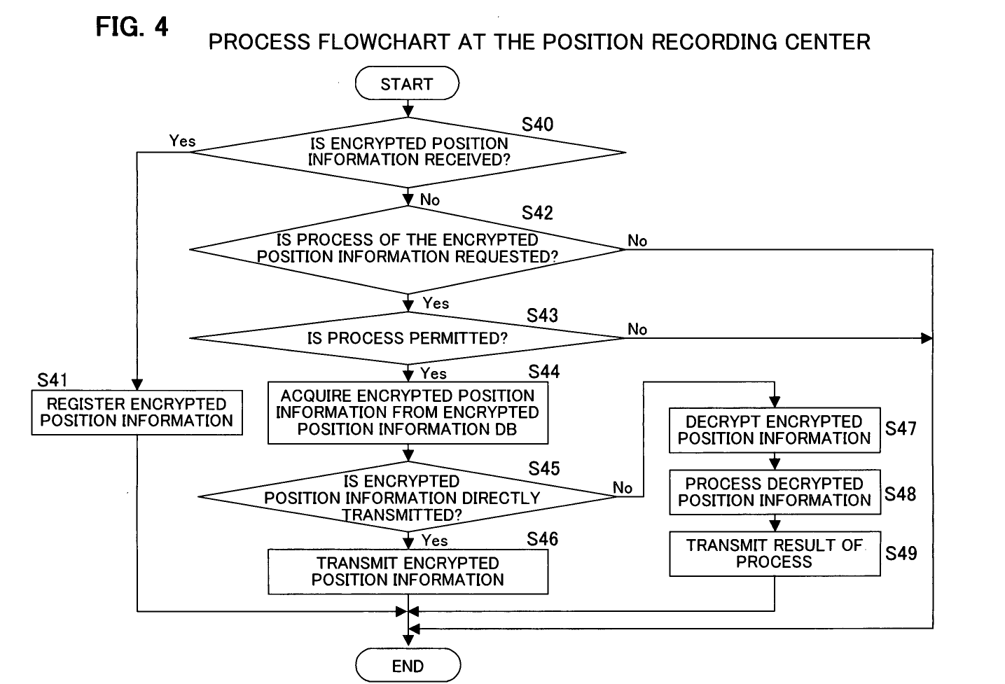

FIG. 4 is a schematic process flowchart for the position recording center 20. In the position recording center 20, when the encrypted position information is received from the terminal 10 (S40), the registration unit 202 registers the encrypted position information into the encrypted position information database 201 (S41). Similarly, when a request for processing the encrypted position information is received from the terminal 10 or the position information service center 30 (S42), the acquisition unit 203 determines whether to permit/not to permit the process (S43). In the case where the process is permitted, the acquisition unit 203 acquires the requested encrypted position information from the encrypted position information database 201 (S44). In the case where the acquired encrypted position information is directly transmitted to the originator of the request (the terminal 10 or the position information service center 30) (S45), the acquired encrypted position information is transmitted as the response (S46). In other cases (when a predetermined process is applied to the encrypted position information), the decryption unit 206 decrypts the acquired encrypted position information (S47), the position information processing unit 208 executes a predetermined process to the decrypted position information (S48) and the result of the process is transmitted to the originator of the request (S49).

<Mode of Uses>

Mode of uses of the position information system according to the embodiment of the invention will be described.

(Mode of Use 1)

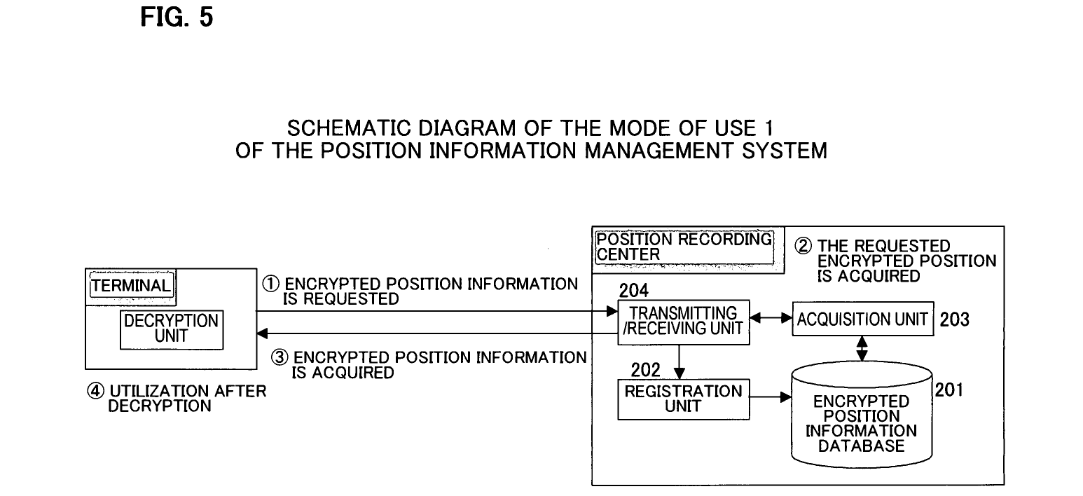

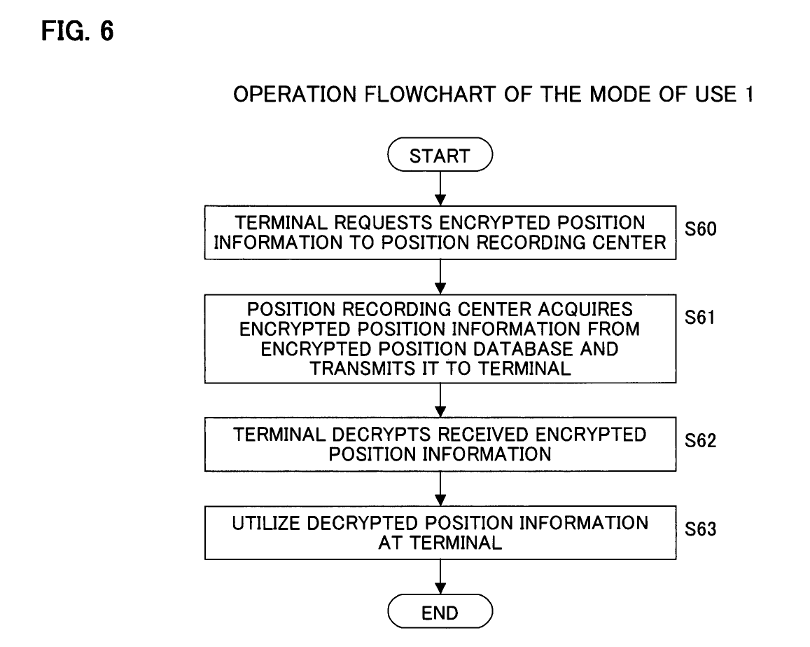

A mode of use 1 is a case where a user being a mobile body takes out from the position recording center 20 and utilizes the user's own position information/past trace. FIGS. 5 and 6 show the flowcharts of the process for the case. In the mode of use 1, the user him/herself utilizes his/her own position information. Specific examples of the use are as follows.

To confirm the position to or traces on which the user moved written in the user's diary, in a travel or a mountain climbing.

To find out the place where the user was at a designated time on a designated day.

Referring to FIG. 5, FIG. 6 will be described. First, a request for acquiring the encrypted position information of the user him/herself for a predetermined time or a predetermined time period is transmitted from the terminal 10 to the position recording center 20 (S60). The position recording center 20 permits the request for the process when the user him/herself has requested his/her own position information. Having received the request, the center 20 acquires from the encrypted position information database 201 the encrypted position information corresponding to the user ID contained in the request for the predetermined time or a predetermined time period, and transmits the acquired information to the terminal 10 as the response (S61). The terminal 10 decrypts the received encrypted position information (S62) and the user utilizes the position information (S63).

As described above, each mobile body can obtain its own past positions since the history of the position information for each mobile body is accumulated in the position recording center 20. The privacy of the mobile body can be protected since the position information is accumulated and transmitted in the encrypted state.

(Mode of Use 2)

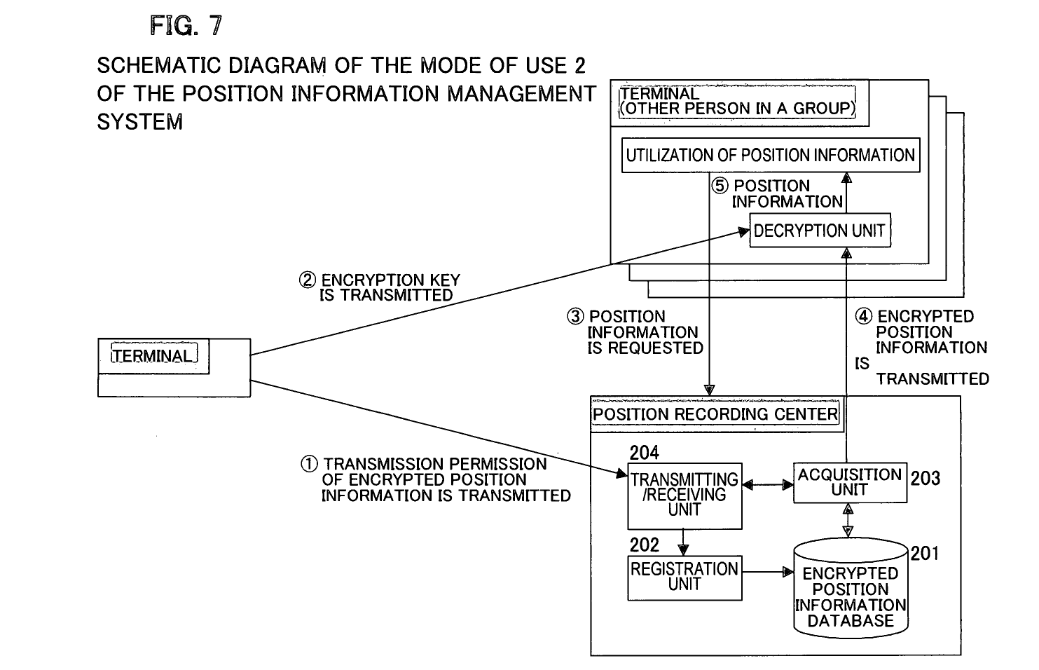

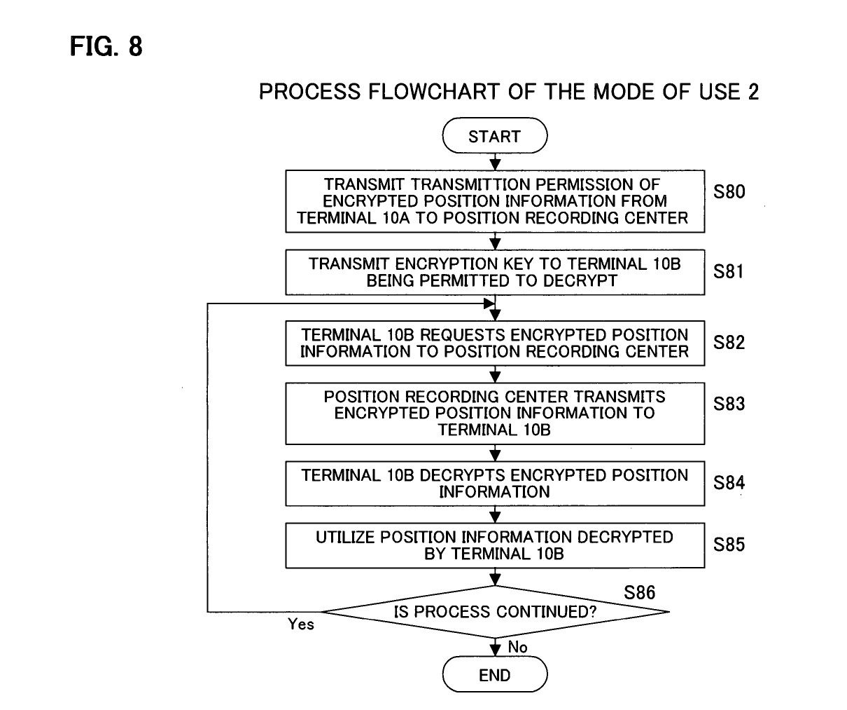

A mode of use 2 is a case where a user B being another user than a user A utilizes the position information of the user A. That is, position information/trace information is shared in a group/community (among a plurality of users). FIG. 7 is a schematic diagram of the mode of use 2 and FIG. 8 is its process flowchart. The characteristic of the mode of use 2 is that the user B can decrypt the encrypted position information of the user A by transmitting the encryption key to the terminal 10 of the user B from the user A.

Specific examples of the mode of use for the above case are as follows.

To display on each other's terminal each other's position between friends.

To manage positions where the staff members of a company are.

Referring to FIG. 7, FIG. 8 will be described. First, transmission permission information has been transmitted in advance from a terminal 10A of the user A to the position recording center 20, which permits the center 20 to transmit the encrypted position information of the user A to the terminal 10B of the user B (S80). The position recording center 20 stores the transmission permission information in a predetermined storage apparatus. The transmission permission information includes predetermined transmission permission conditions such as the time period during which the transmission is permitted. Then, the encryption key for decrypting the encrypted position information of the user A (the encryption key stored in the terminal 10A) is transmitted from the terminal 10A of the user A to the terminal 10B of the user B (A81). The terminal 10B of the user B transmits a request for obtaining the encrypted position information of the user A for a predetermined time or a predetermined time period (A82). Having received the request for the process, the position recording center 20 determines whether to permit or not the transmission based on the above transmission permission information from the user A. In the case where the transmission is permitted, the center 20 obtains the encrypted position information of the user A from the encrypted position information database 201 and transmits it to the terminal 10B of the user B (S83). Having received the encrypted position information, the terminal 10B decrypts the encrypted position information using the encryption key from the terminal 10A (S84). Then, the user B utilizes the decrypted position information (S85). When the terminal 10B further requests the encrypted position information of the user A (S86), the process returns to Step S82.

In this manner, the position recording center 20 does not transmit the position information of the user A to another user B as far as there is no permission from the user A. Furthermore, user B can not decrypt the position information of the user A as far as the user B has not obtained the encryption key from the user A since the position information is encrypted. Therefore, no unauthorized user can know any position information and the position information can be shared among a plurality of users.

(Mode of Use 3)

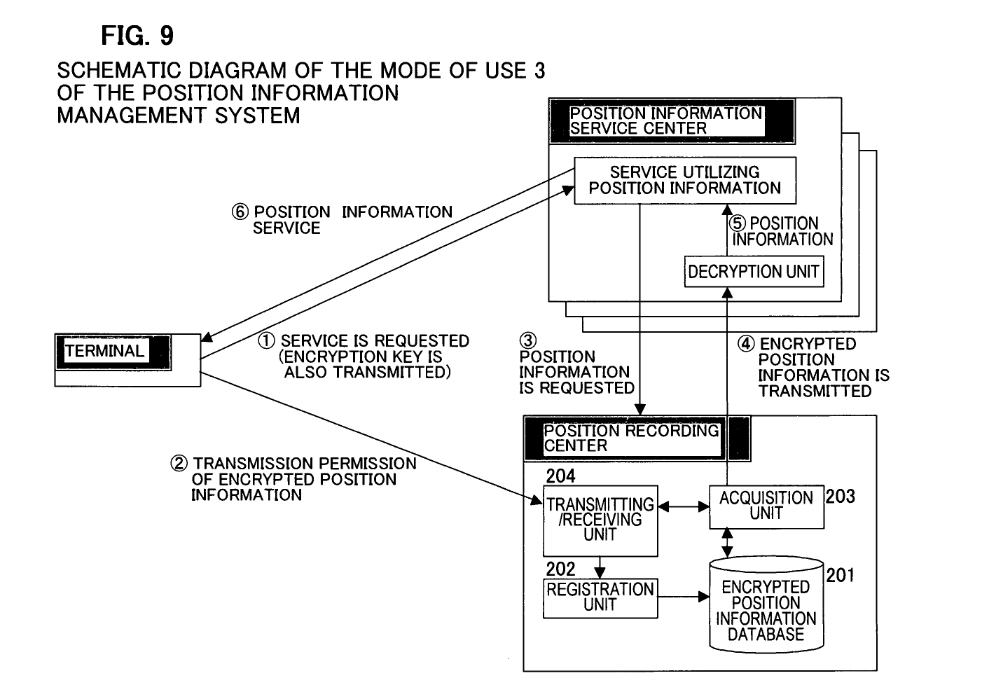

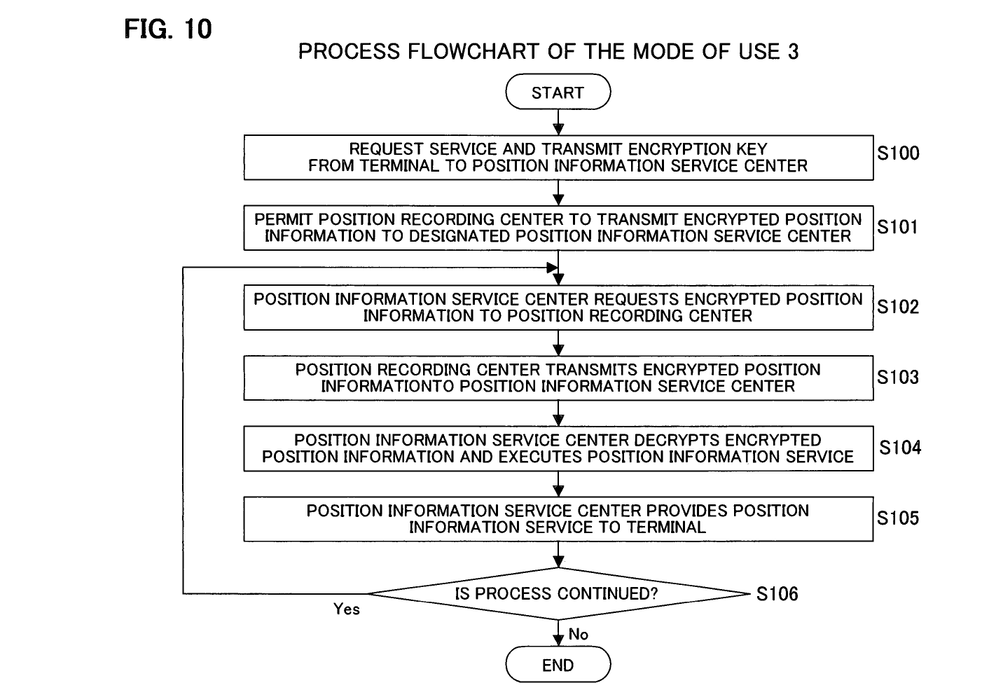

A mode of use 3 is a case where a user utilizes the position information service center 30. FIG. 9 is a schematic diagram of the mode of use 3 and FIG. 10 is its process flowchart. The characteristic of the mode of use 3 is that a user has delivered his/her encryption key to the position information service center 30 and decryption of the encrypted position information is executed by the position information service center 30.

Specific examples of the use of the mode of use 3 are as follows.

To receive provision of position information services (for example, information about a town created utilizing the current position information) from the position information service center 30.

Emergency notice service.

Referring to FIG. 9, FIG. 10 will be described. First, a request for a predetermined position information service is transmitted from the terminal 10 of a user to the position information service center 30 (S100). At this moment, the encryption key of the terminal 10 of the user is transmitted together with the request for the position information service. Furthermore, transmission permission information is transmitted from the terminal 10 of the user to the position recording center 20, which permits the position information service center to transmit the encrypted position information of the user (S101). The position recording center 20 stores the transmission permission information in a predetermined storage apparatus. The transmission permission information includes predetermined transmission permission conditions such as a time period during which the transmission is permitted. The position information service center 30 transmits a request for acquiring the encrypted position information of the user for a predetermined time (including the present) or a predetermined time period (S102). Having received the request, the position recording center 20 acquires the encrypted position information of the user from the encrypted position information database 201 after confirming the above transmission permission information from the user, and transmits the acquired information to the position information service center 30 (S103) Having received the encrypted position information, the position information service center 30 decrypts the encrypted position information using the encryption key from the terminal 10 and executes a predetermined process (S104). For example, the position information service center 30 acquires the current position of the user and executes a retrieving process of information about stores around the position. The position information service center 30 transmits the result of the process to the terminal 10 (S105) When the position information service center 30 further requests the encrypted position information of the user (S106), the process returns to Step S102.

Since the position recording center 20 transmits only the position information permitted by the user (mobile body) to the position information service center 30 as described above, the user can receive the provision of the services of the position information service center 30 while the position information of the user is not known without any restriction.

(Mode of Use 4)

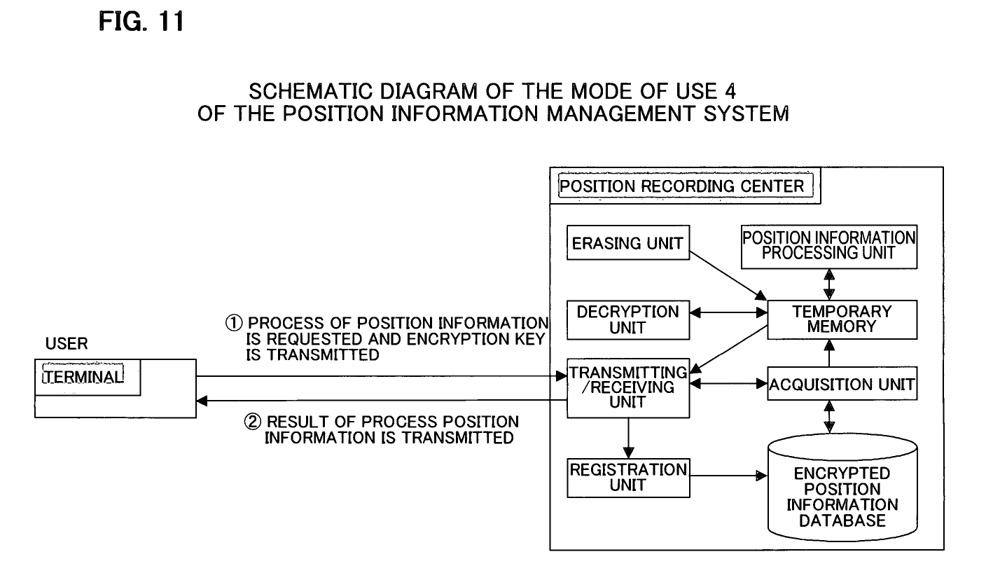

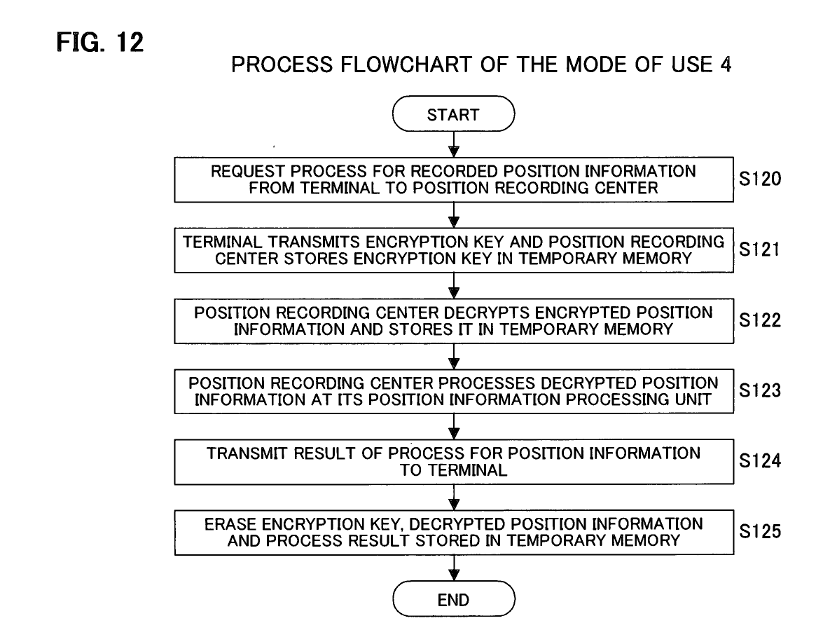

In a mode of use 4, the terminal 10 of the user receives the result of the process executed to the information based on the position information of the terminal 10 itself, from the position recording center 20. The user sends its encryption key to the position recording center 20. The decryption unit 206 of the position recording center 20 decrypts the encrypted position information. Then, the position information processing unit 208 of the position recording center 20 executes a process using the decrypted position information and sends the result of the process to the terminal 10. FIG. 11 is a schematic diagram of a mode of use 4 and FIG. 12 is a process flowchart of the mode of use 4.

The position information processing unit 208 of the position recording center 20 executes processes such as a statistical process of the position information/trance information recorded in the encrypted position information database 201.

Specific examples of the process contents/use are as follows.

To calculate the number of times of visits and the frequency of visits for each place, from the position information until the present.

To calculate the time necessary for designated courses.

To calculate the date at, the time at and the time period for which the user was at a designated place.

Referring to FIG. 11, FIG. 12 will be described. First, a request for a predetermined position information process is transmitted from the terminal 10 of the user to the position recording center 20 (S120). At this moment, the encryption key of the terminal 10 of the user is transmitted together with the request for the position information process. The position recording center 20 stores the received encryption key in its temporary memory 205 (S121) The acquisition unit 203 of the position recording center 20 acquires the encrypted position information of the user designated by the request for the process. The decryption unit 206 decrypts the encrypted position information using the encryption key stored in the temporary memory 205 and stores the decrypted position information in the temporary memory 205 (S122). The position information processing unit 208 of the position recording center 20 reads out the decrypted position information from the temporary memory 205, executes a predetermined process (S123) and transmits the result of the process to the terminal 10 after storing the result of the process in the temporary memory 205 (S124). After transmitting the result of the process, the erasing unit 207 of the position recording center 20 erases each of the data of encryption key, the decrypted position information and the result of the process stored in the temporary memory 205 (S125).

Since the position recording center 20 decrypts the encrypted position information, executes the predetermined process and transmits the result of the process to the terminal 10 of the user as described above, the terminal 10 needs not to have a function for processing the position information and the structure of the terminal 10 can be simplified.

Furthermore, even when the encrypted position information is decrypted in the position recording center 20, the position recording center 20 erases the encryption key, the decrypted position information and the result of the process, after the process. Therefore, the privacy of the mobile body (user) has no possibility of being infringed in the position recording center 20. In a mode of use 5 and 6 described as follows, the position recording center 20 also decrypts the encrypted position information. However, similarly to the above, the privacy of the mobile body (user) can be protected by erasing the information relating to the privacy of the mobile body (user).

(Mode of Use 5)

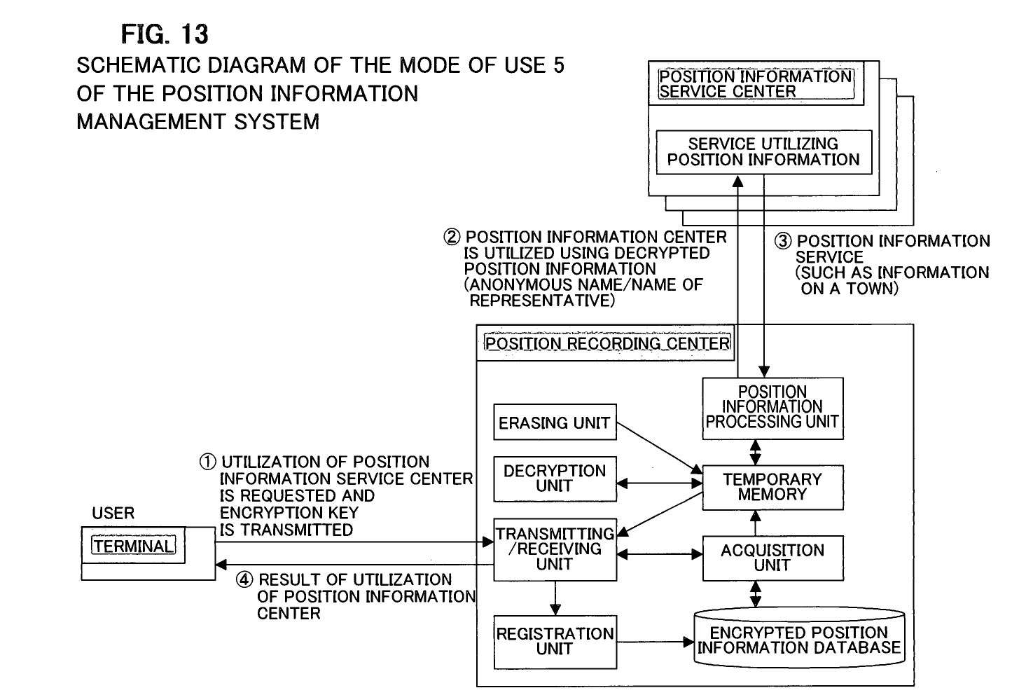

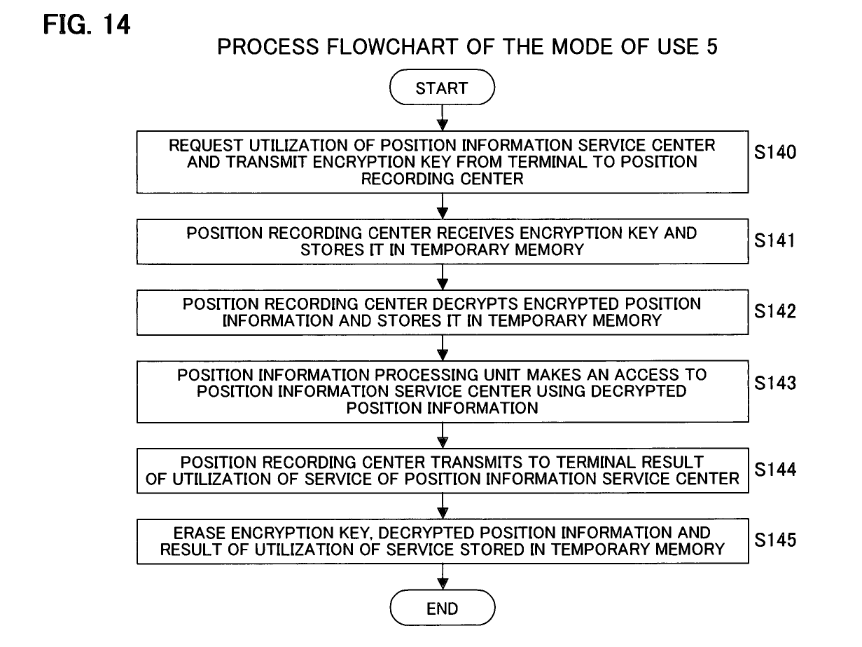

In the mode of use 5, the position recording center 20 is utilized as a mediator when the user utilizes the position information services. The difference of this mode of use from the mode of use 3 is that the encryption key is sent to the position recording center 20 and the encrypted position information is decrypted in the position recording center 20. FIG. 13 is a schematic diagram of the mode of use 5 and FIG. 14 is its process flowchart.

The user may designate directly a position information service center 30 that the user would like to use, or may designate only the position information service that the user would like to obtain without designating any position information service center and the position recording center may select a position information service center.

The position recording center 20 may send the result of the use of the position information service center 30 to the information terminal of the user without changing its format, or may send the result of compilation of the results of the use.

Specific examples of the use of the mode of use 5 are as follows.

To know the information about a town around the current position.

To know the sightseeing courses around the current position.

Referring to FIG. 13, FIG. 14 will be described. First, a request for a predetermined position information service to the position information service center 30 is transmitted from the terminal 10 of the user to the position recording center 20 (S140). At this moment, the encryption key of the terminal 10 of the user is transmitted together with the request for the position information service. The position recording center 20 stores the received encryption key in its temporary memory 205 (S141). The acquisition unit 203 of the position recording center 20 acquires the encrypted position information of the user designated by the request for the service. The decryption unit 206 decrypts the encrypted position information using the encryption key stored in the temporary memory 205 and stores the decrypted position information in the temporary memory 205 (S142). The position information processing unit 208 of the position recording center 20 reads out the decrypted position information from the temporary memory 205, and transmits the decrypted position information and the above request for the position information service to the position information service center 30 (S143). The position information service center 30 executes a service process in response to the received position information and returns the result of the process as a response to the position recording center 20. The position recording center 20 transmits the result of the process to the terminal 10 after storing the result of the process in the temporary memory 205. (S144). After transmitting the result of the process, the erasing unit 207 of the position recording center 20 erases each data of the encryption key, the decrypted position information, the result of the process stored in the temporary memory (S145).

Since the position recording center 20 decrypts the encrypted position information and uses, substituting for the user, the position information service center 30 as described above, the mobile body (user) can utilize the position information service center 30 without informing the position information service center 30 of its name.

Furthermore, since the position recording center 20 makes an access to a plurality of position information service centers 30 substituting for the mobile body (user) when the mobile body would like to use a plurality of position information service centers 30, the user can use the plurality of the position information service centers by making an access to only one (1) of the position recording center 20.

(Mode of Use 6)

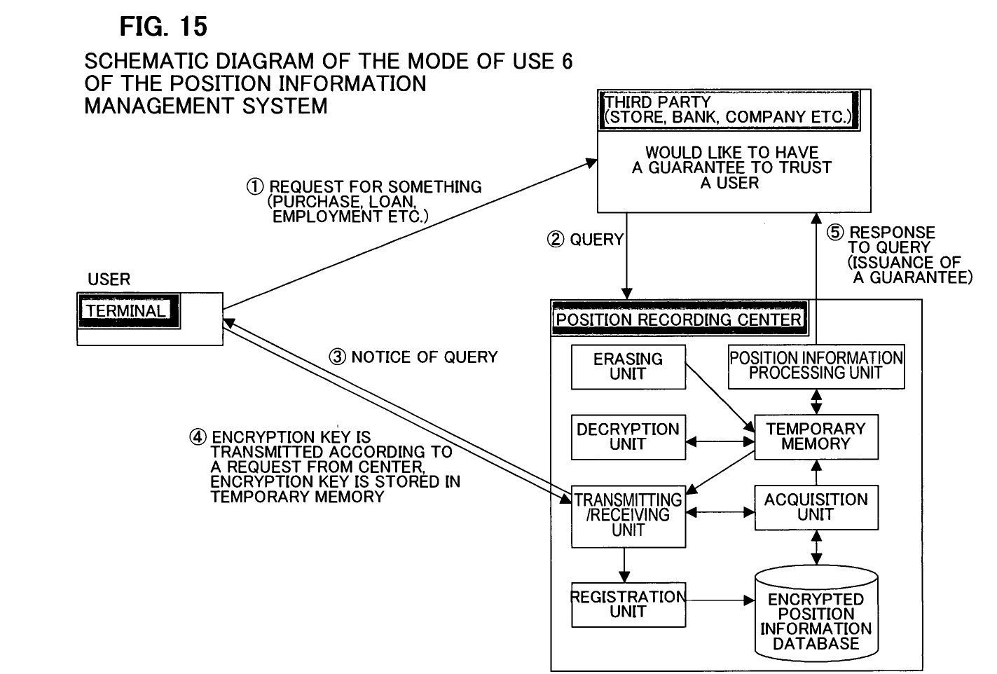

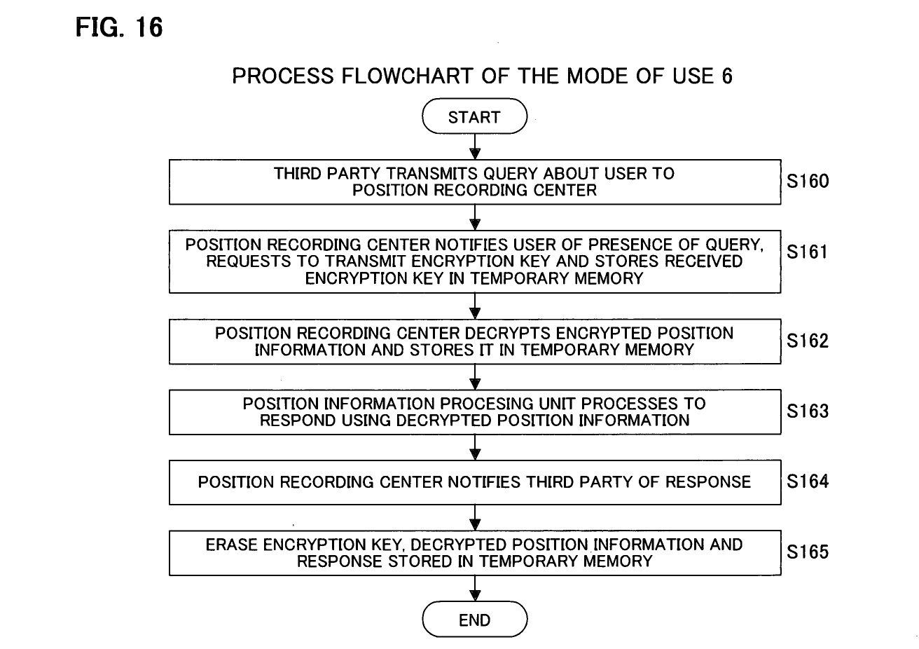

In the mode of use 6, the position recording center 20 creates a response based on the position information that the position recording center 20 has recorded, in response to a querying request relating to the position of a mobile body (user), from a third party, and transmits the response to the third party. Since the position recording center 20 records the encrypted position information unchangeably, it functions as a guarantee apparatus guaranteeing the position of the mobile body (user). The response to the third party may be in a form of, for example, an issuance of a warranty or a certificate. FIG. 15 is a schematic diagram of the mode of use 6 and FIG. 16 is its process flowchart.

Specific examples of the querying request and the response are as follows. The querying request is issued at the conclusion of a contract such as sales/purchase, loan, employment etc. For example, they are the case where a user concludes a sales/purchase agreement or a loan agreement with a third party, where a third party confirms the address of a user, where a user concludes an employment agreement with a third party, where a third party confirms the educational background and the professional experience of a user etc.

Queries

a) Would like to know the current position of a mobile body (user).

b) Would like to know whether a mobile body is/was at the place queried.

c) Would like to know the place where a mobile body was on a date and at a time queried.

d) Would like to know the data on and the time at which a user was at a designated place.

e) Would like to know whether a mobile body was at the place queried on the data queried at the time queried.

f) Would like to know whether or not the address and the work place that a user has declared are correct.

g) Would like to know whether or not the resume of a user is correct.

Responses:

a) Response with the current position of the targeted mobile body.

b) Yes/No.

c) Response with the place where the mobile body was at the time queried.

d) Response with the data on and the time at which the user was at the place queried.

e) Yes/No.

f) For example, the address may be determined to be correct if the targeted mobile body (user) frequently stays at the place having the address in the middle of the night. Similarly, the work place is determined to be correct if the targeted mobile body frequently goes to the place having the address of the workplace in the daytime.

g) For example, it is determined to be correct that the user went to a school if the user frequently went to a place where the school is during the time period in which the user should have been going to the school.

Referring to FIG. 15, FIG. 16 will be described a third party transmits a request for querying a position of a user from its terminal 10C to the position recording center 20 (S160). Having received the request for querying the position, the position recording center 20 notifies the terminal 10A of the user that there has been a request for querying the position from the third party. Having received the notice, the terminal 10 of the user transmits its encryption key to the position recording center 20 in the case where the terminal 10 permits the center 20 to respond to the request. The position recording center 20 stores the received encrypted key in the temporary memory 205 (S161).

The decryption unit 206 of the position recording center 20 decrypts the encrypted position information corresponding to the request for querying the position, using the encryption key stored in the temporary memory 205, and stores the decrypted position information in the temporary memory 205 (S162). The position information processing unit 208 creates a response to the request for querying the position based on the decrypted position information (S163) and notifies the terminal 10C of the third party of the response (S164). The response may be notified, for example, as a warranty issued by the position recording center 20. After notifying the response, the erasing unit 207 of the position recording center 20 erases each data of the encryption key, decrypted position information and the response stored in the temporary memory 205 (S165).

Since the encrypted position information accumulated in the position recording center 20 can not be altered as described above, the position recording center 20 can provide a guarantee function utilizing the position information.

The scope of the invention to be protected is not limited to the above embodiment and covers the inventions according to the following claims and their equivalents.

Industrial Applicability

As set forth hereinabove, according to the invention, the position information measured by a terminal of a mobile body is encrypted and transmitted to a position recording center. Then, the position recording center accumulates the position information of each mobile body in the encrypted state. The mobile body, and a position information service center providing predetermined position information services can not decrypt the position information of a person stored in a position recording apparatus without the permission of the person. Therefore, it is possible to manage the position information of the mobile body without infringing the privacy of the mobile body. Furthermore, high-level security can be secured since the position recording apparatus itself can not decrypt the accumulated position information without obtaining the encryption key from the mobile body.

What is claimed is:

1. A position information management system managing position information of a mobile body, comprising:
a terminal for measuring the position of the mobile body, encrypting the measured position information by predetermined encryption means and transmitting the encrypted position information; and
a position recording apparatus for receiving the position information and recording the position information in a state where it is encrypted.

2. The position information management system according to claim 1, wherein
the position recording apparatus transmits to the terminal the encrypted position information of the mobile body corresponding to the terminal, based on a request from the terminal, and wherein
the terminal decrypts the encrypted position information using the decryption data that the terminal retains.

3. The position information management system according to claim 1, wherein
when the position recording apparatus has received predetermined permission information from a first terminal, the position recording apparatus transmits the encrypted position information of the mobile body corresponding to the first terminal, based on a request from a second terminal, and wherein
when the second terminal has received the decryption data retained by the first terminal from the first terminal, the second terminal can decrypt the encrypted position information.

4. The position information management system according to claim 1, wherein
when the position recording apparatus has received predetermined permission information from the terminal, the position recording apparatus transmits the encrypted position information of a mobile body corresponding to the terminal, to a position information service center, based on a request from the position information service center providing predetermined services to the terminal, and wherein
when the position information service center has received the decryption data retained by the terminal from the terminal, the position information service center decrypts the encrypted position information, executes a predetermined process for the decrypted position information and transmits the result of the process to the terminal.

5. The position information management system according to claim 1, wherein
when the position recording apparatus has received the decryption data retained by the terminal from the terminal, the position recording apparatus, based on a request from the terminal, decrypts the encrypted position information of a mobile body corresponding to the terminal using the decryption data, executes a predetermined process for the decrypted position information and transmits the result of the process to the terminal.

6. The position information management system according to claim 1, wherein
when the position recording apparatus has received the decryption data retained by the terminal from the terminal, the position recording apparatus, based on a request from the terminal, decrypts the encrypted position information of a mobile body corresponding to the terminal using the decryption data and transmits the decrypted position information to a position information service center providing predetermined services to the terminal, and wherein
the position information service center executes a predetermined process for the decrypted position information and transmits the result of the process to the position recording apparatus, and wherein
the position recording apparatus transmits the result of the process to the terminal.

7. The position information management system according to claim 1, wherein
when the position recording apparatus has received predetermined permission information from the terminal, the position recording apparatus, based on a request from a third party, decrypts the encrypted position information of a mobile body corresponding to the terminal using the decryption data, executes a predetermined process for the decrypted position information and transmits the result of the process to the third party.

8. The position information management system according to claim 7, wherein
the predetermined process is a process for responding to a query relating to a mobile body corresponding to the terminal.

9. The position information management system according to claim 8, wherein
the position recording center has a guarantee function for the response.

10. The position information management system according to claim 8, wherein
the query is at least one of “where is the current position of the mobile body”, “whether the mobile body is/was at a designated place”, “whether the mobile body is/was at a designated place on a designated date at a designated time”, “where is the position at which the mobile body was on a designated date at a designated time” and “on which data and at what time the mobile body was at a designated place”.

11. The position information management system according to claim 1, wherein
the terminal comprises a plurality of encryption means, and is capable of switching the encryption means for encrypting the position information, based on the position of the terminal and/or the time, or on an instruction from a mobile body.

12. The position information management system according to claim 1, wherein
the terminal comprises a personal authentication means for a mobile body, and wherein
when a personal authentication is successfully completed, the terminal can measure the position of the mobile body, encrypt the measured position in formation with predetermined encryption means and transmit the encrypted position information.

13. The position information management system according to claim 1, wherein
when the position recording apparatus receives the decryption data from the terminal and decrypts the encrypted position information using the decryption data,
the position recording apparatus stores in a temporary memory the decryption data, the decrypted position information and the result of a predetermined process executed for the decrypted position information and erases from the temporary memory the decryption data, the decrypted position information and the result of the process after transmitting the result of the process to the terminal.

14. The position information management system according to claim 13, wherein
the position recording apparatus executes the predetermined process.

15. The position information management system according to claim 13, wherein
the position recording apparatus transmits the decrypted position information to a position information service center providing predetermined services utilizing the position information and receives from the position information service center the result of the predetermined process executed by the position information service center.

16. A terminal comprising:
a measuring unit for measuring the position of a mobile body;
an encryption unit for encrypting the measured position information by predetermined encryption means;
a communication unit for transmitting the encrypted position information; and
decryption unit having decryption data for decrypting the encrypted position information, the decryption unit when receiving the position information from the communication unit, decrypting the received position information using the decryption data.

17. A position recording apparatus comprising:
a communication for receiving encrypted position information relating to the position of at least one mobile body, from a terminal of the mobile body; and
a database in which the position information is recorded in the encrypted state.

18. The position recording apparatus according to claim 17, further comprising:
an acquisition unit for acquiring the position information recorded in the database, in response to a predetermined request, wherein
the communication unit transmits the acquired position information from the communication unit in the encrypted state.

19. The position recording apparatus according to claim 17, further comprising:
an acquisition unit for acquiring the position information recorded in the database, in response to a predetermined request; and
a decryption unit for decrypting the acquired encrypted position information, wherein
when the decryption unit receives, together with the request, the decryption data for decrypting the encrypted position information, the decryption unit decrypts the acquired encrypted position information and transmits the decrypted position information.

20. The position recording apparatus according to claim 17, further comprising:
an acquisition unit for acquiring the position information recorded in the database, in response to a predetermined request;
a decryption unit for decrypting the acquired encrypted position information; and
a processing unit for executing a predetermined process for the decrypted position information, wherein
when the decryption unit receives, together with the request, the decryption data for decrypting the encrypted position information, the decryption unit decrypts the acquired encrypted position information and the processing unit transmits the result of the predetermined process executed for the decrypted position information.

21. The position recording apparatus according to claim 20, further comprising:
a temporary memory for storing the decryption data, the decrypted position information and the result of the process; and
an erasing unit for erasing the decryption data, the decrypted position information and the result of the process from the temporary memory after transmitting the result of the process.
